(19) United States
(12) Patent Application Publication
(10) Pub. No.: US 2026/0143323 A1
(43) Pub. Date: May 21, 2026

(54) TESTING EMERGENCY SERVICES USING A HEARTBEAT MESSAGE

(71) Applicant: T-Mobile USA, Inc., Bellevue, WA (US)

(72) Inventors: Hang Hoi Yau, Sammamish, WA (US); William Michael Hooker, Seattle, WA (US)

(21) Appl. No.: 18/951,332

(22) Filed: Nov. 18, 2024

(51) Int. Cl. H04W 4/90; H04W 4/029; H04W 24/08

(52) U.S. Cl. CPC H04W 4/90; H04W 4/029; H04W 24/08

(57) ABSTRACT

Systems and methods for testing a communication connection between a telecommunications network and a public safety answering point (PSAP) are described herein. To test a PSAP, a telecommunications network transmits a heartbeat message to the PSAP. The heartbeat message is a special purpose message that includes a header or other data that indicates the message is a test message. The PSAP determines if the message received from the network is a heartbeat message or an emergency call. Upon determining that a heartbeat message was received, the PSAP transmits a success response to the network, indicating that there is a communication connection between the telecommunications network and the PSAP to service emergency calls.

### BACKGROUND

An individual can request emergency services, such as fire and police services, from a public safety answering point (PSAP) by playing an emergency call using a specially allocated number (e.g., 9-1-1) for the PSAP. As network capabilities have progressed, increasingly people are able to request emergency services using the PSAP via other technologies such as text (e.g., text to 9-1-1). The status of the PSAP can be determined using various methods. One way of determining the status of the PSAP can be the monitoring of emergency calls coming into the PSAP and determining if those calls connected to the PSAP. Another way of determining the status of the PSAP can be to make test calls, which are calls that are non-emergency calls that a network can monitor if the test calls are connected. However, test calls may not be a preferred method, as the PSAP may consider the calls to be actual emergency calls and the test call may inadvertently allocate resources that may be needed for an actual emergency call that may be placed during the same time.

The presently disclosed subject matter is directed to aspects of improving the operation of a PSAP.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a schematic diagram of an illustrative wireless communication network environment to test the availability of a public safety answering point (PSAP) using a heartbeat message may be implemented, in accordance with some examples of the present disclosure.

FIG. 2 is an example call flow for testing a public safety answering point, in accordance with some examples of the present disclosure.

FIG. 3 is an illustrative process for testing a public safety answering point, in accordance with some examples of the present disclosure.

FIG. 4 depicts a component level view of a PSAP server for use with the systems and methods described herein, in accordance with some examples of the present disclosure.

### DETAILED DESCRIPTION

Examples of the present disclosure can comprise systems and methods for testing connections to public safety answering point (PSAP) using a special purpose session initiation protocol (SIP) message, sometimes referred to herein as a “heartbeat” message. As used herein, a PSAP is a dedicated call center that receives emergency calls and texts. The PSAP processes the calls and texts and dispatches emergency services accordingly. In some examples, the heartbeat call is used to verify that PSAP is connected to a telecommunications network so that if an emergency call is made using the telecommunications network, the emergency call can be established. In examples of the present disclosure, a special purpose message, such as a test SIP INVITE message, is transmitted using the telecommunications network to a PSAP. The test SIP INVITE message is configured to test the communications connections up to the PSAP. However, rather than causing the PSAP to establish an emergency call, upon determining that the special purpose message comprises a heartbeat message, the PSAP acknowledges by transmitting a success response, such as an SIP 200OK to the telecommunications network. If the telecommunications network does not receive the success response, in some examples, the telecommunications network can transmit a second heartbeat message. If the second, or additional, heartbeat messages do not result in the receipt of a success response, the telecommunications network can perform additional operations such as, but not limited to, transmitting a notification to a PSAP command center indicating that the PSAP connection test and the subsequent PSAP connection test(s) were unsuccessful. The PSAP command center can include a main or central system that overseas, monitors, is responsible for, or controls the PSAP to which the test was conducted.

The present disclosure further includes a PSAP that is able to discern between a heartbeat message and a message to establish an emergency call with a user or another entity. The PSAP may be configured to extract a portion of an SIP INVITE message. If the portion includes a header or other data indicating that the SIP INVITE is a heartbeat message, the PSAP transmits an acknowledgement message, such as an SIP 200OK, to the telecommunications network. If the SIP INVITE message does not include the heartbeat header or other data indicating that the SIP INVITE is a heartbeat message, the PSAP will commence a connection process with the telecommunications network to establish an emergency call with the PSAP. In addition to transmitting the success response, the PSAP may also perform one or more secondary operations in response to receiving the heartbeat message to test additional features or operations of the PSAP. For example, the PSAP may be configured to transmit a text message or establish a communication connection with a designation telephone number to test, among other operations, that the PSAP is able to notifications when an emergency call is received.

The heartbeat message, e.g., a test SIP INVITE, may be generated using various technologies. For example, an initiation trigger to cause the generation of the heartbeat message may be received from an authorized source such as personnel in charge of testing one or more PSAPs, a manager of the PSAP, a technician at the telecommunications network, and the like. Additionally, the authorized source may be one or more processes or operations at the telecommunications network (such as a timer) or an operation of the PSAP (such as a self-test). In some examples, the timer may be used to generate the initiation trigger when a period of time has elapsed. In other examples, the initiation trigger may be generated in response to a notification by an emergency management service indicating an event (e.g., a severe weather event) or a condition that may impact an area serviced by the PSAP or the PSAP itself. For example, the event or condition may include, but is not limited to, a severe storm. In another example, the initiation trigger may be generated in response to receiving an alert from a utility provider, such as an electrical power supplier, indicating that electrical power may have been interrupted or there was a power outage in an area serviced by the PSAP or the PSAP itself.

The systems and methods discussed herein are discussed generally with respect to cellular UEs, tablets, computers, and the like, and in terms of components (e.g., network entities) associated with Wi-Fi networks, Bluetooth networks, wired networks, fourth generation (4G) and fifth generation (5G) cellular networks, and other types of networks. The systems and methods can be used with other types of equipment and on other types of networks, however, where users may wish to have increased flexibility in sending and receiving calls, video calls, and messages. Thus, the systems and methods described herein are described in terms of the 4G and 5G networks merely because these networks represent the state of the current art. One of skill in the art will recognize, however, the systems and methods could also be used on other networks that provide video calling such as, for example, Internet of Things (IoT), machine-to-machine (M2M), sixth generation (6G), and other current and future networks.

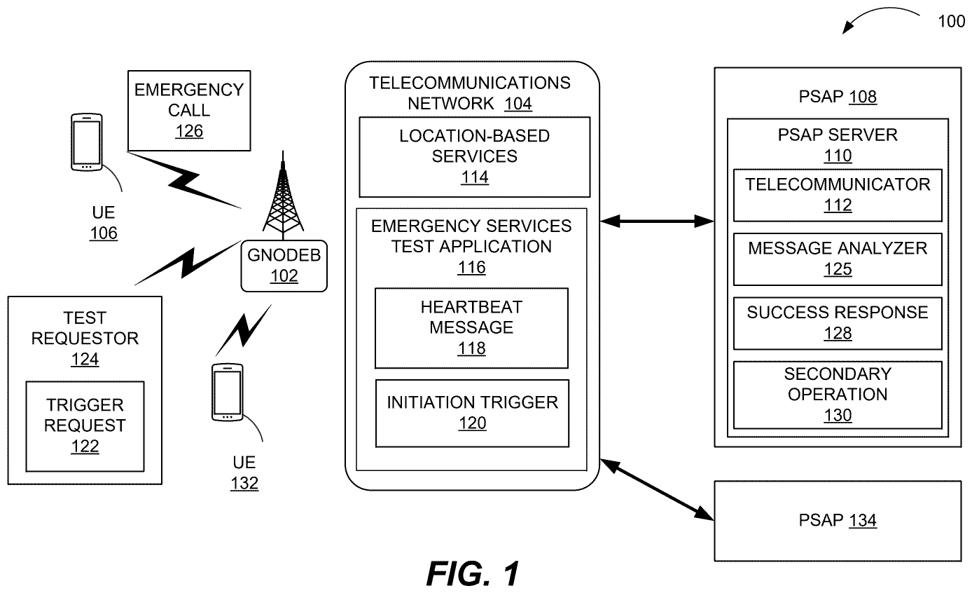

FIG. 1 is a schematic diagram of an illustrative wireless network environment 100 in which the disclosed systems and techniques may be implemented, in accordance with examples of the disclosure. The environment 100 includes a gNodeB 102. While referred to as an “gNodeBs” for explanatory purpose herein, the gNodeB 104 may be any type or number of base stations, including, but not limited to, any type of BTS, NodeB, eNodeB, gNodeB, etc. The gNodeB 104 may communicate with other components and functions in a telecommunications network 104. The illustration of one gNodeB 104 is merely for purposes of simplicity, as multiple base stations may be used to service multiple devices in the environment 100. The telecommunications network 104 may be any one or more networks that facilitate communications between particular devices, components, and/or functions of various types in the core of a wireless communications network that may facilitate communication between computing device and/or mobile devices, such as a user equipment (UE) 106. Various connections between components and functions in the telecommunications network 104 may be wired, wireless, or a combination thereof. The components and functions described herein may be implemented as physical devices, as software components executing on one or more computing devices, any combination thereof.

In various embodiments, the telecommunications network 104 may facilitate the establishment of communications sessions for one or more wireless devices, such as the UE 106, a public safety answering point (PSAP) 108, and/or other services (not shown). For example, the UE 106 may be used by a user (not shown) to initiate an emergency call with the PSAP 108. In conventional voice systems, a user (not shown) may initiate a voice call to the PSAP 108 using an abbreviated number dedicated to emergency services, such as “9-1-1” in the United States. The call is routed by the telecommunications network 104 to the PSAP 108. It should be noted that other networks or network components, including third party services, may be involved in routing an originating call from the UE 106 to the PSAP 108. Any additional components necessary to route a call from the UE 106 to the PSAP 108 are known to those of ordinary skill in the relevant art. Once the call is received at the PSAP 108, a PSAP server 110 routes the call to a telecommunicator 112. In some examples, the telecommunicator 112 may be called a dispatcher. The telecommunicator 112 receives the call at the telecommunicator's 112 station (not shown), determines the services needed, such as police, fire, and medical emergency services, and routes those services to the appropriate location.

In conventional versions of PSAPs, the location of the UE 106 was readily available, as the UE 106 was typically a landline assigned to a particular address or location. When the call was connected, the telecommunicator 112 received the address of the UE 106. However, it is increasingly becoming prevalent where the UE 106 is not a landline assigned to a particular location, but rather, a mobile device (such as a cell phone, table, laptop computer, and the like) that can be moved from location to location. In these examples, some PSAPs 108 use location-based services 114 to provide the location of the UE 106 to the PSAP 108. The location-based services 114 may be part of the telecommunications network 104 or may be other services that can provide a location of the UE 106 to the PSAP 108.

As noted above, it is common to test connections to the PSAP 108 to ensure that the PSAP 108 is operational and able to receive and handle emergency calls. However, as noted above, testing emergency services can use bandwidth that may be needed by other devices in emergency situations. For example, if there was a major incident in a building, hundreds of devices may be trying to access the PSAP 108. If the PSAP 108 is receiving a test message on its emergency line that gets routed to the telecommunicator 112, the telecommunicator 112 or other functions of the PSAP 108 may be unable to service actual emergencies because of resources used for responding to test message. To provide for the testing of the PSAP 108, the telecommunications network 104 comprises an emergency services test application (test application) 116. The test application 116 may be a function of the telecommunications network 104 as illustrated in FIG. 1 or may be a testing service provided by a third-party. The present disclosure is not limited to any particular configuration. The test application 116 generates a heartbeat message 118 upon the receipt of an initiation trigger 120. As noted above, the initiation trigger 120 can be based on a timer that cause causes the test application 116 to generate and transmit the heartbeat message 118 to the PSAP at regular time intervals. In another example, the initiation trigger 120 may be generated upon the receipt of a trigger request 122 from a test requestor 124. The test requestor 124 can include, but is not limited to, an authorized source such as personnel in charge of testing one or more PSAPs, a manager of the PSAP, a technician at the telecommunications network, one or more processes or operations at the telecommunications network, a self-test requested by the PSAP 108 itself, an emergency management service a utility provider, and the like. The present disclosure is not limited to any particular type of test requestor 124.

The heartbeat message 118 may include a header or other data that, when received by the PSAP 108, causes the PSAP 108 to issue a success message rather than commence the establishment of an emergency call. The PSAP server 110 uses a message analyzer 125 to determine if the message received from the telecommunications network 104 is the heartbeat message 118 received from the telecommunications network 104 or an emergency call 126 received from the UE 106. Upon determining that the message received is the emergency call 126 using the message analyzer 125, the PSAP 108 commences the connection process with the telecommunications network 104 to establish the emergency call between the PSAP 108 and the UE 106. If the PSAP 108 determines that a message received is the heartbeat message 118 using the message analyzer 125, the PSAP 108 generates and transmits a success response 128 to the telecommunications network 104 test application 116 indicating a successful test.

In some examples, the PSAP server 110 may further include a secondary operation 130 that uses the receipt of the heartbeat message 118 to test other functions of the PSAP 108. In some examples, the secondary operation 130 comprises testing at least one function of the PSAP 108 without establishing the emergency call 126 with the PSAP 108. In another example, the secondary operation 130 comprises transmitting a text message to a designated telephone or establishing a communication connection with the designated telephone number, such as a UE 132. In some examples, the UE 132 may be a device used by personnel responsible for testing the operation of the PSAP 108. In some examples, if the telecommunications network 104 does not receive the success response 128 after a predetermined number of transmissions of the heartbeat message 118, the test application 116 may generate and transmit the heartbeat message 118 to another PSAP, such as PSAP 134. This may be done for various reasons including, but not limited to, finding other PSAPs to which the emergency call 126 may be routed, testing the heartbeat message 118 itself, and the like.

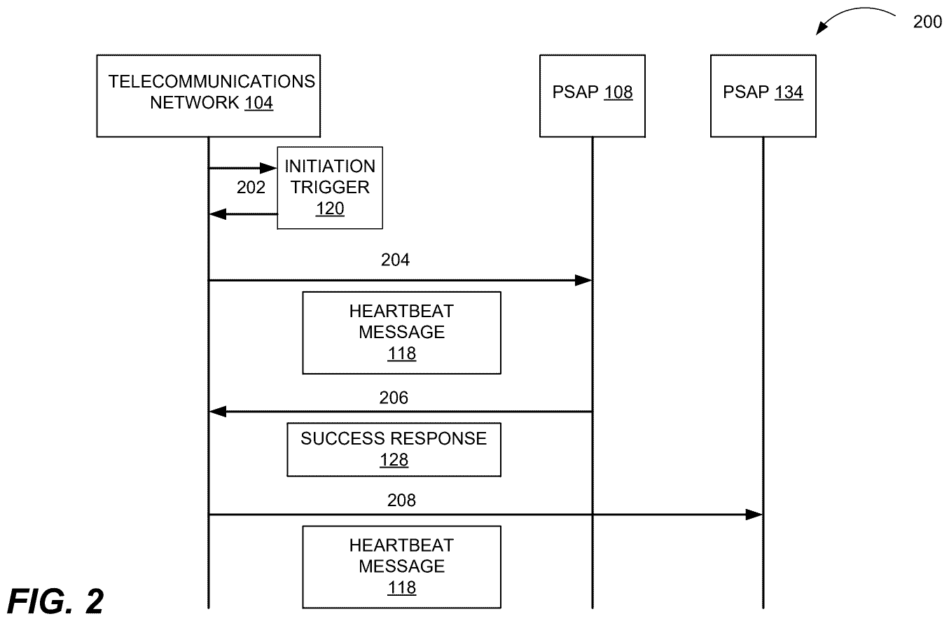

FIG. 2 is an illustrative call flow 200 for using the heartbeat message 118 to test connections to the PSAP 108 without initiating an emergency call, in accordance with examples of the disclosure. The call flow 200 commences at 202, where the initiation trigger 120 is received at the telecommunications network 104. In an example, the initiation trigger 120 can be based on a timer that cause causes the test application 116 to generate and transmit the heartbeat message 118 to the PSAP at regular time intervals. In another example, the initiation trigger 120 may be generated upon the receipt of a trigger request 122 from a test requestor 124. The test requestor 124 can include, but is not limited to, an authorized source such as personnel in charge of testing one or more PSAPs, a manager of the PSAP, a technician at the telecommunications network, one or more processes or operations at the telecommunications network, a self-test requested by the PSAP 108 itself, an emergency management service a utility provider, and the like. The present disclosure is not limited to any particular type of test requestor 124.

The call flow 200 continues to 204, where, in response to the initiation trigger 120, the telecommunications network 104 transmits the heartbeat message 118 to the PSAP 108. The heartbeat message may be in the form of modified SIP message with a header or other data that indicates that the heartbeat message 118 is not the emergency call 126, but rather, a test message.

The call flow 200 continues to 206, where, in response to receiving the heartbeat message 118, the PSAP 108 transmits the success response 128 to inform the telecommunications network 104 that the heartbeat message 118 was successfully received and processed by the PSAP.

In some examples, if the success response 128 is not received by the telecommunications network 104 after a transmission of the heartbeat message 118, at 208, the telecommunications network 104 may retransmit the heartbeat message 118 to the PSAP 134. In such examples, the telecommunications network 104 may transmit the heartbeat message 118 for a predetermined number of times when there is a lack of a success response 128 from the PSAP 134 to each corresponding heartbeat message 118 transmission. For instance, the telecommunications network 104 may determine that there is no success response when a success response is not received within a predetermine amount of time from the transmission of a corresponding heartbeat message by the telecommunications network 104. Once the telecommunication network 104 has transmitted the heartbeat message 118 for the predetermined number of times without receiving any success response, the telecommunications network 104 may perform one or more other actions, such as transmitting a notification to a computing device at a PSAP command center of the PSAP 134 indicating that the test was unsuccessful, transmitting a heartbeat message to an alternative PSAP, and/or so forth.

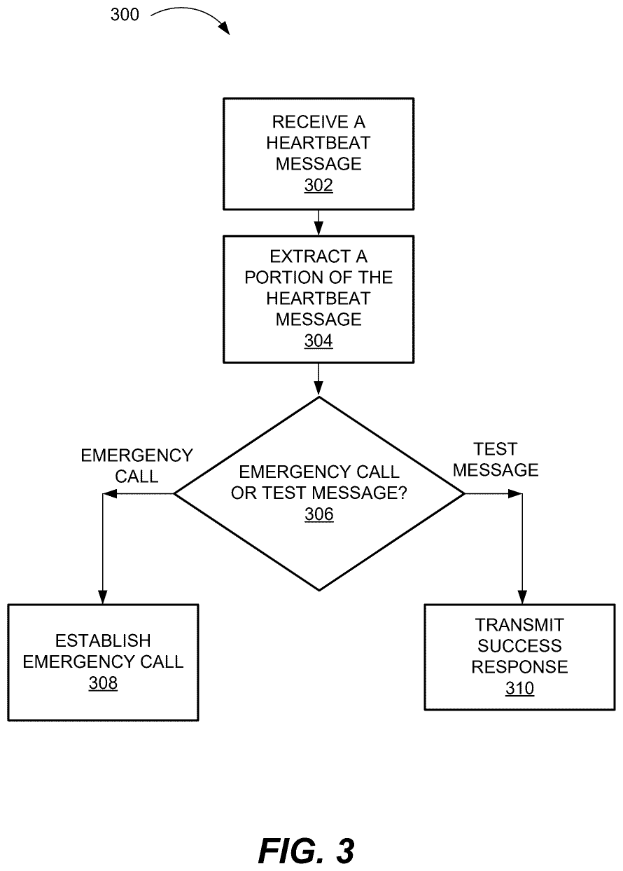

FIG. 3 illustrates a process 300 for using the heartbeat message 118 to test connections to the PSAP 108 without initiating an emergency call, in accordance with examples of the disclosure. The process and other processes described herein are illustrated as example flow graphs, each operation of which may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Referring to FIG. 3, the process 300 commences at operation 302, where the PSAP 108 receives a test message. In some examples, the test message is the heartbeat message 118. The heartbeat message 118 may be a special purpose SIP INVITE message having a header or other data indicating that the SIP INVITE is the heartbeat message 118 and not the emergency call 126.

The process 300 continues to operation 304, where the message analyzer 125 extracts a portion of the heartbeat message 118 to determine if the heartbeat message 118 is a test message or an emergency call. The message analyzer 125 may extract, or otherwise analyze, the heartbeat message 118 header or other data.

The process 300 continues to operation 306, where the message analyzer 125 determines, using the extracted portion, if the heartbeat message 118 is a test message or an emergency call. If at operation 306, the message analyzer 125 determines that the heartbeat message 118 is in fact an emergency call, the process 300 continues to operation 308, whereby the PSAP 108 will commence a connection process with the telecommunications network 104 to establish the emergency call 126 with the PSAP 108. If at operation 306, the message analyzer 125 determines that the heartbeat message 118 is a test message in the form of the heartbeat message 118, the process 300 continues to operation 310, whereby the PSAP 108 will transmit a success response to the telecommunications network.

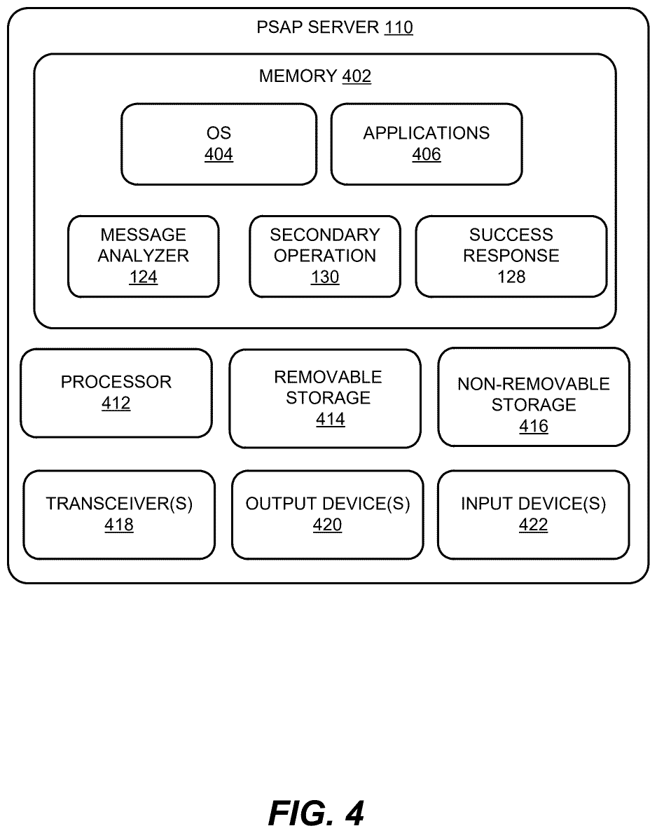

FIG. 4 depicts a component level view of the PSAP server 110 for use with the systems and methods described herein. The PSAP server 110 could be any device capable of communicating using the telecommunications network 104. The PSAP server 110 can comprise several components to execute the above-mentioned functions. As discussed below, the PSAP server 110 can comprise memory 402 including an operating system (OS) 404 and one or more standard applications 406. The standard applications 406 can comprise a video call application, an audio call application, and a messaging application to enable users to engage in audio calls, video calls, and messaging, among other things.

The PSAP server 110 can also comprise one or more processors 412 and one or more of removable storage 414, non-removable storage 416, transceiver(s) 418, output device(s) 520, and input device(s) 522. In various implementations, the memory 402 can be volatile (such as random access memory (RAM)), non-volatile (such as read only memory (ROM), flash memory, etc.), or some combination of the two. The memory 402 can include all, or part, of the message analyzer 125. In some examples, rather than being stored in the memory 402, some, or all, of the message analyzer 125 can be stored on a remote server or a cloud of servers accessible by the PSAP server 110.

The memory 402 can also include the OS 404. The OS 404 varies depending on the manufacturer of the PSAP server 110. The OS 404 contains the modules and software that support basic functions of the PSAP server 110, such as scheduling tasks, executing applications, and controlling peripherals. In some examples, the OS 404 can enable the message analyzer 125, the secondary operation 130, and the generation of the success response 128, and provide other functions, as described above, via the transceiver(s) 418. The OS 404 can also enable the PSAP server 110 to send and retrieve other data and perform other functions.

The PSAP server 110 can also comprise one or more processors 412. In some implementations, the processor(s) 412 can be one or more central processing units (CPUs), graphics processing units (GPUs), both CPU and GPU, or any other processing unit. The PSAP server 110 may also include additional data storage devices (removable and/or non-removable) such as, for example, magnetic disks, optical disks, or tape. Such additional storage is illustrated in FIG. 4 by removable storage 414 and non-removable storage 416.

Non-transitory computer-readable media may include volatile and nonvolatile, removable and non-removable tangible, physical media implemented in technology for storage of information, such as computer readable instructions, data structures, program modules, or other data. The memory 402, removable storage 414, and non-removable storage 416 are all examples of non-transitory computer-readable media. Non-transitory computer-readable media include, but are not limited to, RAM, ROM, electronically erasable programmable ROM (EEPROM), flash memory or other memory technology, compact disc ROM (CD-ROM), digital versatile discs (DVD) or other optical storage, magnetic cassettes, magnetic tape, magnetic disk storage or other magnetic storage devices, or any other tangible, physical medium which can be used to store the desired information and which can be accessed by the PSAP server 110. Any such non-transitory computer-readable media may be part of the PSAP server 110 or may be a separate database, databank, remote server, or cloud-based server.

In some implementations, the transceiver(s) 418 include any transceivers known in the art. In some examples, the transceiver(s) 418 can include wireless modem(s) to facilitate wireless connectivity with other components (e.g., between the PSAP server 110 and a wireless modem that is a gateway to the Internet), the Internet, and/or an intranet. Specifically, the transceiver(s) 418 can include one or more transceivers that can enable the PSAP server 110 to send and receive data, video calls, audio calls, and messages and to perform other functions. Thus, the transceiver(s) 418 can include multiple single-channel transceivers or a multi-frequency, multi-channel transceiver to enable the PSAP server 110 to send and receive video calls, audio calls, messaging, etc. The transceiver(s) 418 can enable the PSAP server 110 to connect to multiple networks including, but not limited to 2G, 3G, 4G, 5G, and Wi-Fi networks. The transceiver(s) can also include one or more transceivers to enable the PSAP server 110 to connect to future (e.g., 6G) networks, Internet-of-Things (IoT), machine-to machine (M2M), and other current and future networks.

The transceiver(s) 418 may also include one or more radio transceivers that perform the function of transmitting and receiving radio frequency communications via an antenna (e.g., Wi-Fi or Bluetooth®). In other examples, the transceiver(s) 418 may include wired communication components, such as a wired modem or Ethernet port, for communicating via one or more wired networks. The transceiver(s) 418 can enable the PSAP server 110 to make audio and video calls, download files, access web applications, and provide other communications associated with the systems and methods, described above.

In some implementations, the output device(s) 420 include any output devices known in the art, such as a display (e.g., a liquid crystal or thin-film transistor (TFT) display), a touchscreen, speakers, a vibrating mechanism, or a tactile feedback mechanism. Thus, the output device(s) can include a screen or display. The output device(s) 420 can also include speakers, or similar devices, to play sounds or ringtones when an audio call or video call is received. Output device(s) 420 can also include ports for one or more peripheral devices, such as headphones, peripheral speakers, or a peripheral display.

In various implementations, input device(s) 422 include any input devices known in the art. For example, the input device(s) 422 may include a camera, a microphone, or a keyboard/keypad. The input device(s) 422 can include a touch-sensitive display or a keyboard to enable users to enter data and make requests and receive responses via web applications (e.g., in a web browser), make audio and video calls, and use the standard applications 406, among other things. In some examples, the input device(s) 422 may be a communication cable connected between the PSAP server 110 and a device such that communications between the PSAP server 110 and the device is a wired connection. The touch-sensitive display or keyboard/keypad may be a standard push button alphanumeric multi-key keyboard (such as a conventional QWERTY keyboard), virtual controls on a touchscreen, or one or more other types of keys or buttons, and may also include a joystick, wheel, and/or designated navigation buttons, or the like. A touch sensitive display can act as both an input device 422 and an output device 420.

Some aspects of the presently disclosed subject matter are described in additional detail in the following clauses:

Clause 1. A method of testing a public safety answering point (PSAP) connection of a PSAP serviced by a telecommunications network, the method comprising: receiving an initiation trigger to test the PSAP connection for a PSAP; commencing a PSAP connection test in response to receiving the initiation trigger; generating a test session initiation protocol (SIP) INVITE message; transmitting, using a telecommunications network, the test SIP INVITE message to the PSAP through the PSAP connection; receiving a success response through the PSAP connection; and in response to receiving the success response, ending the PSAP connection test without establishing call.

Clause 2. The method of clause 1, further comprising: receiving an indication that a period of time has elapsed; and generating the initiation trigger upon receiving the indication that the period of time has elapsed.

Clause 3. The method of clause 1, further comprising: receiving a request to generate the initiation trigger from an authorized source; and generating the initiation trigger upon receiving the request from the authorized source.

Clause 4. The method of clause 3, wherein the authorized source comprises an operation at the telecommunications network or an operation received from the PSAP.

Clause 5. The method of clause 1, further comprising: receiving an alert from an emergency management service indicating a severe weather event has impacted or will impact an area serviced by the PSAP; and generating the initiation trigger upon receiving the alert from the emergency management service.

Clause 6. The method of clause 1, further comprising: receiving an alert from an electrical power supplier indicating that electrical power may have been interrupted in an area serviced by the PSAP; and generating the initiation trigger upon receiving the alert from the electrical power supplier.

Clause 7. The method of clause 1, further comprising: in response to not receiving the success response, attempting a second PSAP connection test without establishing call; and upon determining that the second PSAP connection test is unsuccessful, transmitting a notification to a PSAP command center indicating that the PSAP connection test and the second PSAP connection test were unsuccessful.

Clause 8. A PSAP comprising: a memory storing computer-executable instructions; and a processor in communication with the memory, the computer-executable instructions causing the processor to: receive a SIP INVITE message from a telecommunications network; determine if the SIP INVITE message comprises an emergency call or a test message comprising a heartbeat request; upon determining that the SIP INVITE message comprises an emergency call, commence a connection process with the telecommunications network to establish the emergency call with the PSAP; and upon determining that the SIP INVITE message comprises the heartbeat request; transmit a success response to the telecommunications network.

Clause 9. The PSAP of clause 8, further comprising computer-executable instructions that cause the processor to perform an act comprising transmitting a request to the telecommunications network to transmit the SIP INVITE message.

Clause 10. The PSAP of clause 9, wherein transmitting a request to the telecommunications network to transmit the SIP INVITE message is performed in response to a power outage in an area serviced by the PSAP.

Clause 11. The PSAP of clause 8, further comprising computer-executable instructions that cause the processor to perform an act comprising performing a secondary operation upon determining that the SIP INVITE message comprises the heartbeat request.

Clause 12. The PSAP of clause 11, wherein the secondary operation comprises testing at least one function of the PSAP without establishing the emergency call with the PSAP.

Clause 13. The PSAP of clause 12, wherein the secondary operation comprises transmitting a text message to a designated telephone number or establishing a communication connection with the designated telephone number.

Clause 14. The PSAP of clause 8, wherein the computer-executable instructions that cause the processor to determine if the SIP INVITE message comprises an emergency call or a heartbeat request comprises computer-executable instructions that cause the processor to: extract a portion of the SIP INVITE message; and determine that the portion indicates that the SIP INVITE message comprises an instruction to transmit the success response and not an instruction to establish the emergency call with the PSAP.

Clause 15. A non-transitory computer-readable storage medium having computer-executable instructions stored thereupon that, when executed by a computer, cause the computer to perform acts comprising: receiving an initiation trigger to test a PSAP connection for a PSAP; commencing a PSAP connection test in response to receiving the initiation trigger; generating a test session initiation protocol (SIP) INVITE message; transmitting, using a telecommunications network, the test SIP INVITE message to the PSAP through the PSAP connection; receiving a success response through the PSAP connection; and in response to receiving the success response, ending the PSAP connection test without establishing call.

Clause 16. The non-transitory computer-readable storage medium of clause 15, further comprising computer-executable instructions stored thereupon that, when executed by the computer, cause the computer to perform acts comprising: receiving an indication that a period of time has elapsed; and generating the initiation trigger upon receiving the indication that the period of time has elapsed.

Clause 17. The non-transitory computer-readable storage medium of clause 15, further comprising computer-executable instructions stored thereupon that, when executed by the computer, cause the computer to perform acts comprising: receiving a request to generate the initiation trigger from an authorized source; and generating the initiation trigger upon receiving the request from the authorized source.

Clause 18. The non-transitory computer-readable storage medium of clause 17, wherein the authorized source comprises an operation at the telecommunications network or an operation received from the PSAP.

Clause 19. The non-transitory computer-readable storage medium of clause 15, further comprising computer-executable instructions stored thereupon that, when executed by the computer, cause the computer to perform acts comprising: receiving an alert from an emergency management service indicating a severe weather event has impacted or will impact an area serviced by the PSAP; and generating the initiation trigger upon receiving the alert from the emergency management service.

Clause 20. The non-transitory computer-readable storage medium of clause 15, further comprising computer-executable instructions stored thereupon that, when executed by the computer, cause the computer to perform acts comprising: receiving an alert from an electrical power supplier indicating that electrical power may have been interrupted in an area serviced by the PSAP; and generating the initiation trigger upon receiving the alert from the electrical power supplier.

The presently disclosed examples are considered in all respects to be illustrative and not restrictive. The scope of the disclosure is indicated by the appended claims, rather than the foregoing description, and all changes that come within the meaning and range of equivalents thereof are intended to be embraced therein.

What is claimed is:

1. A method of testing a public safety answering point (PSAP) connection of a PSAP serviced by a telecommunications network, the method comprising:
receiving an initiation trigger to test the PSAP connection for a PSAP;
commencing a PSAP connection test in response to receiving the initiation trigger;
generating a test session initiation protocol (SIP) INVITE message;
transmitting, using a telecommunications network, the test SIP INVITE message to the PSAP through the PSAP connection;
receiving a success response through the PSAP connection; and
in response to receiving the success response, ending the PSAP connection test without establishing call.

2. The method of claim 1, further comprising:
receiving an indication that a period of time has elapsed; and
generating the initiation trigger upon receiving the indication that the period of time has elapsed.

3. The method of claim 1, further comprising:
receiving a request to generate the initiation trigger from an authorized source; and
generating the initiation trigger upon receiving the request from the authorized source.

4. The method of claim 3, wherein the authorized source comprises an operation at the telecommunications network or an operation received from the PSAP.

5. The method of claim 1, further comprising:
receiving an alert from an emergency management service indicating a severe weather event has impacted or will impact an area serviced by the PSAP; and
generating the initiation trigger upon receiving the alert from the emergency management service.

6. The method of claim 1, further comprising:
receiving an alert from an electrical power supplier indicating that electrical power may have been interrupted in an area serviced by the PSAP; and
generating the initiation trigger upon receiving the alert from the electrical power supplier.

7. The method of claim 1, further comprising:
in response to not receiving the success response, attempting a second PSAP connection test without establishing call; and
upon determining that the second PSAP connection test is unsuccessful, transmitting a notification to a PSAP command center indicating that the PSAP connection test and the second PSAP connection test were unsuccessful.

8. A PSAP comprising:
a memory storing computer-executable instructions; and
a processor in communication with the memory, the computer-executable instructions causing the processor to:
receive a SIP INVITE message from a telecommunications network;
determine if the SIP INVITE message comprises an emergency call or a test message comprising a heartbeat request;
upon determining that the SIP INVITE message comprises an emergency call, commence a connection process with the telecommunications network to establish the emergency call with the PSAP; and
upon determining that the SIP INVITE message comprises the heartbeat request;
transmit a success response to the telecommunications network.

9. The PSAP of claim 8, further comprising computer-executable instructions that cause the processor to perform an act comprising transmitting a request to the telecommunications network to transmit the SIP INVITE message.

10. The PSAP of claim 9, wherein transmitting a request to the telecommunications network to transmit the SIP INVITE message is performed in response to a power outage in an area serviced by the PSAP.

11. The PSAP of claim 8, further comprising computer-executable instructions that cause the processor to perform an act comprising performing a secondary operation upon determining that the SIP INVITE message comprises the heartbeat request.

12. The PSAP of claim 11, wherein the secondary operation comprises testing at least one function of the PSAP without establishing the emergency call with the PSAP.

13. The PSAP of claim 12, wherein the secondary operation comprises transmitting a text message to a designated telephone number or establishing a communication connection with the designated telephone number.

14. The PSAP of claim 8, wherein the computer-executable instructions that cause the processor to determine if the SIP INVITE message comprises an emergency call or a heartbeat request comprises computer-executable instructions that cause the processor to:
extract a portion of the SIP INVITE message; and
determine that the portion indicates that the SIP INVITE message comprises an instruction to transmit the success response and not an instruction to establish the emergency call with the PSAP.

15. A non-transitory computer-readable storage medium having computer-executable instructions stored thereupon that, when executed by a computer, cause the computer to perform acts comprising:
receiving an initiation trigger to test a PSAP connection for a PSAP;
commencing a PSAP connection test in response to receiving the initiation trigger;
generating a test session initiation protocol (SIP) INVITE message;
transmitting, using a telecommunications network, the test SIP INVITE message to the PSAP through the PSAP connection;
receiving a success response through the PSAP connection; and
in response to receiving the success response, ending the PSAP connection test without establishing call.

16. The non-transitory computer-readable storage medium of claim 15, further comprising computer-executable instructions stored thereupon that, when executed by the computer, cause the computer to perform acts comprising:
receiving an indication that a period of time has elapsed; and
generating the initiation trigger upon receiving the indication that the period of time has elapsed.

17. The non-transitory computer-readable storage medium of claim 15, further comprising computer-executable instructions stored thereupon that, when executed by the computer, cause the computer to perform acts comprising:
receiving a request to generate the initiation trigger from an authorized source; and
generating the initiation trigger upon receiving the request from the authorized source.

18. The non-transitory computer-readable storage medium of claim 17, wherein the authorized source comprises an operation at the telecommunications network or an operation received from the PSAP.

19. The non-transitory computer-readable storage medium of claim 15, further comprising computer-executable instructions stored thereupon that, when executed by the computer, cause the computer to perform acts comprising:
receiving an alert from an emergency management service indicating a severe weather event has impacted or will impact an area serviced by the PSAP; and
generating the initiation trigger upon receiving the alert from the emergency management service.

20. The non-transitory computer-readable storage medium of claim 15, further comprising computer-executable instructions stored thereupon that, when executed by the computer, cause the computer to perform acts comprising:
receiving an alert from an electrical power supplier indicating that electrical power may have been interrupted in an area serviced by the PSAP; and
generating the initiation trigger upon receiving the alert from the electrical power supplier.
